(19) United States
(12) Patent Application Publication
(10) Pub. No.: US 2021/0372362 A1
(43) Pub. Date: Dec. 2, 2021

(54) DEVICE FOR GENERATING HYDROELECTRICITY BY PUMPING AND STORING LIQUID

(71) Applicant: Mohammed Youssef Ibrahim AL-JANDAL, Riyadh (SA)

(72) Inventor: Mohammed Youssef Ibrahim AL-JANDAL, Riyadh (SA)

(21) Appl. No.: 16/630,644

(22) PCT Filed: Aug. 23, 2017
(86) PCT No.: PCT/SA2017/000018

§ 371 Date: Jan. 13, 2020

(30) Foreign Application Priority Data
May 13, 2017 (SA) 117380675

(51) Int. Cl. F03B 17/02

(52) U.S. Cl. CPC F03B 17/025; F05B 2220/706; F05B 2280/1071; F05B 2260/422; F05B 2260/4031

(57) ABSTRACT

The invention relates to a device that generates clean, renewable energy by using gravity. The device generates energy by pumping water in a water well and has a plurality of methods for use. In the case of a single well, the well acts as a battery that stores energy and produces more energy than it stores. The well can store energy in multiple ways, it being possible to store energy during off-peak hours and pump energy during peak hours, benefitting from the cost difference, or to store the excess free energy produced from renewable energy, such as solar energy, wind energy or other types of renewable energy, and pump the energy when same is required. The second use is based on two or more devices of the invention that generate hydroelectrical energy by pumping and storing between the at least two devices, taking turns to charge and produce energy from one well to another. The well can be used in multiple sizes. Whenever the size of the well increases to accommodate the water and the well level rises, the amount of energy and the energy production period increase.

### BACKGROUND OF THE INVENTION

1—Gravity station of power, U.S. Pat. No. 5,646,726, date of publication 15 Apr. 2003.
2—A system and a method for storing energy, U.S. Pat. No. 8,166,760 B2, date of publication Jan. 5, 2012.
3—Gravity as a source of renewable energy, U.S. Pat. No. 6,817,180, date of publication 16 Nov. 2004.
5—A system and a method for storing energy, U.S. Pat. No. 8,737,558, date of publication 27 May 2014.

The present invention aims at overcoming the problems and disadvantages of renewable energy that depends on uncontrollable conditions, such as climate. Examples of such renewable energy include solar power, which can be produced only during daytime and is influenced by dusts; wind energy which cannot produce power permanently as it depends on the climate. In addition, hydroelectricity from dams depends on water level at the dams. Moreover, generating hydroelectricity by pumping and storing, which depends on pumping water to an upper tank when there is an excess power, then using such stored water to generate energy at peak times, is another example. One of the disadvantages for the later method is the long period, as it requires a period not less than one day, one week or one season. Another disadvantage is that it is difficult to find two adjacent water assemblies with two different levels to exchange water between the two levels and generate energy, which is difficult to find, particularly at desert areas. Some people try to overcome such obstacle by using an artificial environment, and compensating for the level difference by making a hole at a hydraulic tube in order that water may be totally pumped beneath that hole to provide potential energy, which is subsequently used to generate power at demand One of the disadvantages for the previous method is the need to transfer the entire water each time from one end to the other for storage or generation of energy. The other disadvantage is that such devices need a period of time to be charged with power, which is multiple times longer than the time needed for generating energy; however, such method may be applied only to benefit from the cost difference. In addition, one of the other disadvantages is that such devices can only be used as huge stations for generating power under continuous supervision.

### SUMMARY OF THE INVENTION

A device for generating and storing hydroelectricity by pumping and storing liquid.

At least one device is to be used:

The mentioned device generates renewable and clean power using gravity. The present device generates power by pumping and storing water in a water well and has multiple methods of use. It may be used as a single well acting as a battery that stores energy and produces more energy than what it stores. It has various storage methods; it may store energy during off-peak hours and pump energy during peak hours, benefiting from the cost difference, or store the excess free energy produced from renewable energy, such as solar energy, mind energy or other types of renewable energy, and pump the energy when same is required. The second use is based on two or more devices of the invention that generate hydroelectric energy by pumping and storing between the at least two devices, taking turns to charge and produce energy from one well to another and consuming the excess energy. The well can be used in multiple sizes. Whenever the size of the well increases to accommodate the water and the well level rises, the amount of energy and the energy production period increase.

### The Components of the Device:

The device is composed of top well cover (2) with holes for controlling pressure inside the well (3). Water turbine (4). A control device of water course (5). A tube for feeding the well with water (6). A buoy for preserving stable water level (7). Water level (8). Water pipe (9) getting out of the well bottom toward the turbine. Water pipe (10) getting out of the turbine back to the well. Spiral spring (11) protecting the piston. A base (12) holding the well and the lateral tube. Small balance ropes (13) to reduce friction between the piston and well wall during lifting. A ring (14) that combines the small robes with the main robe. The main lifting rope (15). The electric lever of the piston (16). The base fixed at the top of the well for holding the electric lever (17). A lateral spring at the well pushing the sensor (18). A sensor (19) for defining the piston location. A hydraulic piston made of a stainless metal (20). A pump for pumping and withdrawing water (21). An external water tank (22). An air pump for pumping and withdrawing air (23). An electric current (24) from the second well that generates energy according to the present invention, wherein the two wells work alternatively to generate and store energy and use the excess energy to charge the other empty well. An electric current (25) from a lateral battery to store the excess produced energy according to the invention to be used as required. An electric current (26) from the excess power generated from the renewable energy, such as solar energy and wind energy or other types of clean and renewable energy. An electric current (27) from an external general electric grid to compensate for shortage in some cases. An electric current (28) generated from water turbine placed inside the well to be consumed, while the excess energy is stored. An extendable and shrinkable helical tube (29) made from rubber and used for combining hosepipes and electrical wires. A twisting tube for pumping water (30). A hose tube for pumping air (31). Electrical wires inserted into the piston (32). An insulator (33) for the tube inserted into the center of the piston, which combines hosepipes and wires and prevents the entry of liquids and air to the center of the piston. A tube (34) coming into the center of the piston containing all liquid pipes and wires therein. A tube inside the piston for pumping water (35). A tube inside the piston for pumping air (36). A circular tube (37) connecting internal cavities of the piston and equivalently distributing air and water among cavities. A gear (38) fixed to the upper and lower lids of the pistons and moves with the lids. Grids (39) fixed at the upper lid of the piston, which prevents the passage of any solid body to the center of the piston at the area opened for the passage of the liquids. One of the slices (40) closing the holes of the pistons and forming part of the lid. The shape of the upper lid after being closed (41). The shape of the lower lid after being closed (42). The shape of the upper lid after being opened (43). The shape of the lower lid after being opened (44). One of the fixed parts (45) of the piston. An internal cavity (46) of one of the fixed parts of the piston, which is used to retain air therein when the piston is lifted to provide the piston with sufficient power to float at water, and to retain liquids therein when the piston is lowered to increase the piston weight and produce huge energy. An inflation port (47). A generator of rotational movement (48). A shaft (49). A gear of rotational movement (50). A ring of the piston (51) made of iron or any stainless metal). A ring of the piston (52) made of rubber. A buoy (53) that closes the water course if the water level reaches its utmost and the internal cavity of the piston is totally filled with water. Lower support of the piston (54). The central area of the piston (55). An automatic control device (56). The cavities (57) of the piston allowing water to pass through it when the piston is lifted. The body (58) of the main empty well used to be filled with liquids, without any leakage, which is run in a hydraulic manner by pumping the liquids from one part to the other to produce and store energy.

### OBJECT OF THE PRESENT INVENTION

1—Reducing the costs of the renewable energy by using a floatable piston that can float from the bottom until the top of the well, thereby reducing the costs of recharging the device.

2—Accelerating the charging of the device with power, that depends on lifting the piston alone and passing water through the piston upon lifting.

3—Maximizing the productivity of energy since the piston is capable of increasing its weight and size, which gives it a higher acceleration for gravity and the ability to generate and produce energy several times more than the energy stored therein.

4—Providing clean renewable energy anytime of the day without stopping.

5—Providing a device that may be used by all social strata, as it can be used at home, factories or as a power generation station.

6—Providing a device for generating clean renewable energy, which is not influenced by the uncontrollable conditions, such as climate.

7—Minimizing the space needed for such devices.

8—The device is run alternatively to charge and produce energy simultaneously, which in turn provides non-stopping energy.

9—Reducing the amount of water used in devices for generating hydroelectricity in order to preserve water from over-evaporation, since, according to the present method, the same amount of water can be continuously recycled in order to generate energy with high efficiency.

### BRIEF DESCRIPTION OF THE DRAWINGS

FIG. 1: A profile of the parts of the well and the piston therein, wherein the following components are shown (1-2-3-4-5-6-7-8-9-10-11-12-13-14-15-16-17-18-19-20-21-22-23-24-25-26-27-28-29-30-31-32-56-58).

FIG. 2: A view of the internal parts of the piston, wherein the following components are shown (30-31-32-33-34-35-36-37-45-46-47-48-49-50-55-53).

FIG. 3: A profile that shows the shape of the cavities inside the piston, together with the fixed parts and the area specialized for the passage of water through the piston, wherein the following components are shown (45-55-57).

FIG. 4: A top view of a moving piston lid as closed and the other one is opened, wherein the following components are shown (38-39-40-41-43-50).

FIG. 5: A bottom view of the moving piston lid as closed and the other one is opened, wherein the following components are shown (42-44-54)

FIG. 6: A profile that indicates the external parts of the piston, wherein the following parts are shown (13-14-15-20-29-30-31-32-33-34-39-40-47-51-52-54).

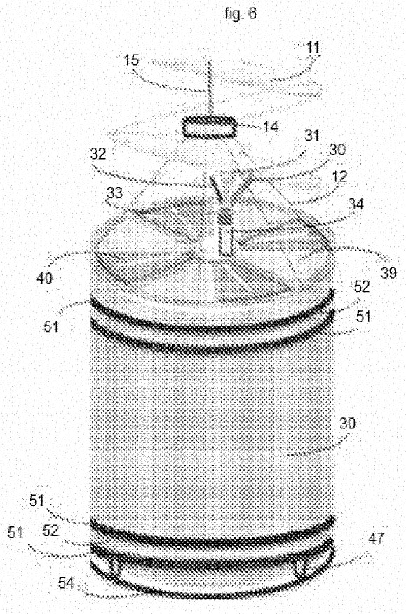

FIG. 7: A profile of the well charged with energy.

FIG. 8: A profile of the well after producing almost all the energy and it needs to be recharged with energy.

### DETAILED DESCRIPTION

The present invention relates to a device for generating hydroelectricity by pumping and storing liquid.

The present method starts with lifting the piston to charge the device with energy through a number of processes:

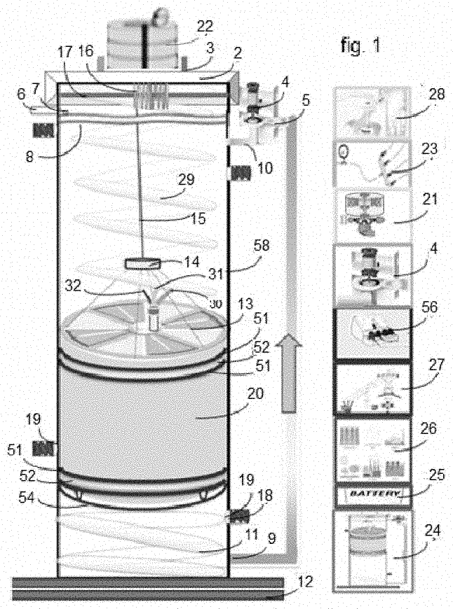

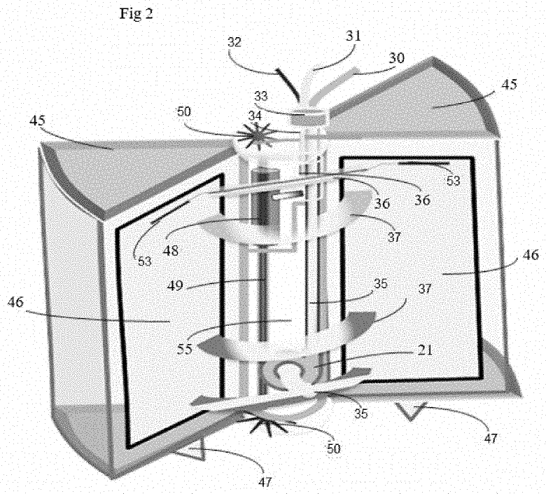

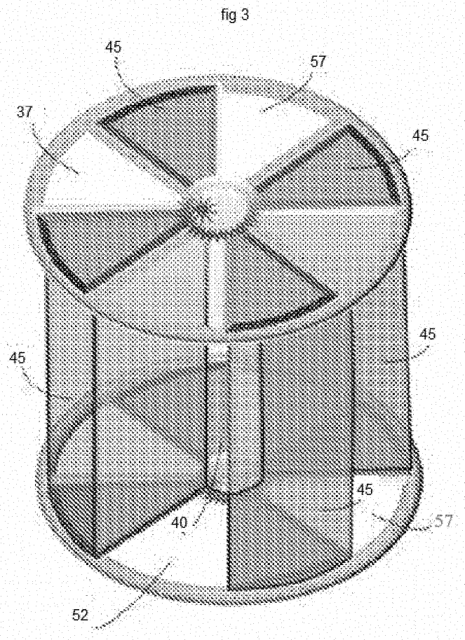

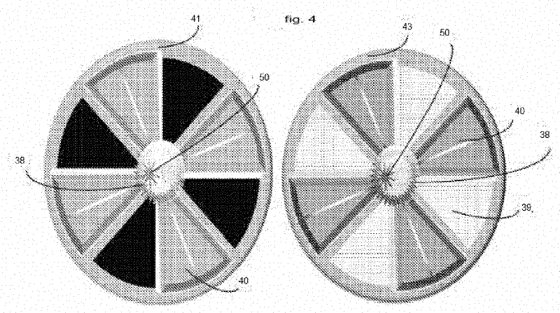

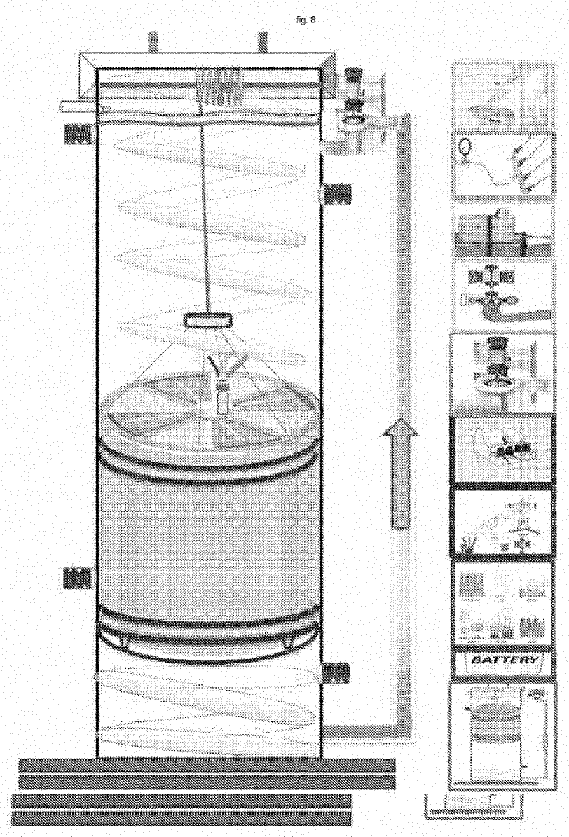

In FIG. 1, the process of lifting the piston starts with making sure that the piston has now reached the downhole by using a sensor (19). In FIG. 3, after ensuring that the piston has reached the downhole, the size of the piston is being minimized at the area facing water by opening the upper and lower areas of the piston to let the water in through the piston (57). In FIG. 2, in order to minimize the piston size, the generator of the rotational movement (48) is switched on to drive the shaft and transfer movement to the upper and lower gears attached thereto (49). The upper and lower gears attached to the shaft transfer the rotational movement to the gears of the upper and lower lids of the piston (50). In FIG. 4, the lid gear moves with the upper closed piston lid to open the area of water passage (42). FIG. 3 shows the area specialized for passing water (57) through the piston while being opened. FIG. 2 shows the inner cavities of the piston (46) through which water will be withdrawn to reduce the piston weight. In FIG. 1, the water pump (21) is run. In FIG. 2, the withdrawn water will be discharged from the piston via tube (35) through hose (30). In FIG. 1, there is shown the external tank (22) specialized for storing the water discharged from the piston. In FIG. 2, while withdrawing water and reducing water level, a buoy (53) will be placed to open the air channel in order to allow the air into the cavities so as to replace water and accelerate the discharging of water. In FIG. 1, the air pump (23) is switched on to pump air through hose (31). FIG. 2 shows a tube (36) through which air is directed into the internal cavities of the piston (46) in order to be filled with air. FIG. 8 shows the piston at downhole, wherein air reduces the weight of the piston and enables it to float at the liquid in order for the piston to be lifted to the top of the well with minimum effort and cost (20). The remaining weight of the piston, if applicable, will be lifted by an electric lever (16) in order to lift the balance ropes of the piston (13) attached to a lifting balance ring (14), which in turn is attached to the main lifting rope (15) entitled to carry the piston upward to the top of the well (20).

### The Method of Generating the Hydroelectricity:

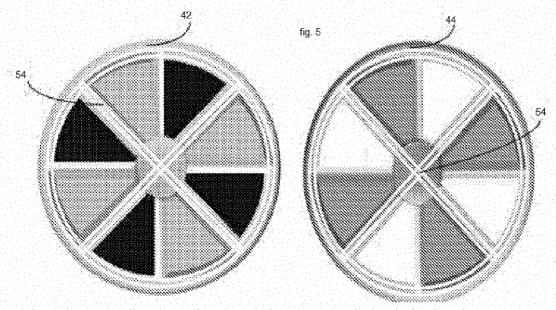

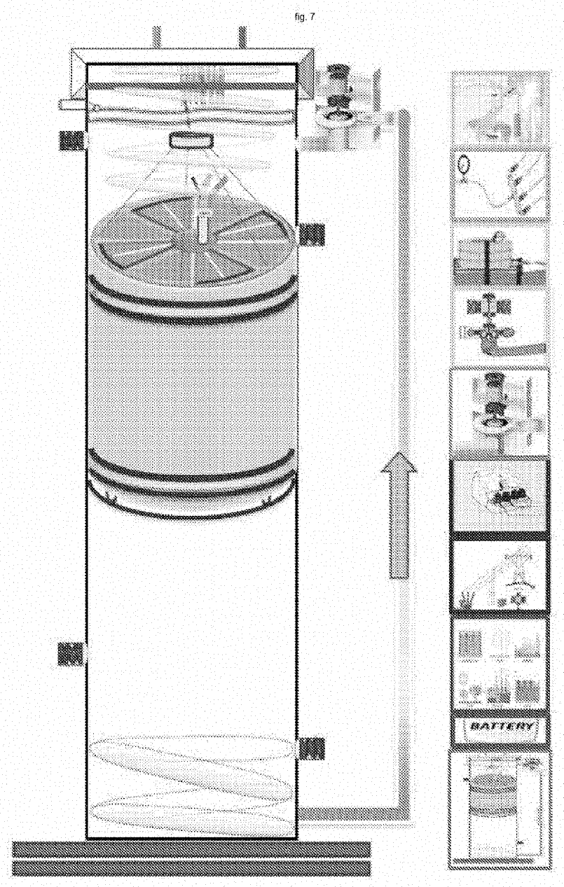

FIG. 7 shows the piston after being lifted (20) to the top of the well (58). A sensor (19) is used to detect that the piston has reached to a counter-current area. Then, the piston is stopped by the electric lever (16) until the weight and size of the piston is increased to produce energy with high efficiency. This can be achieved by closing the cavities specialized for passing water through the piston to increase the volume of the area facing water from the top and the bottom of the piston, while being totally submersed in water to get rid of air and fill the cavities with water in order for the piston to gain more volume and weight in order to be able to compress and displace water existing beneath it with high strength and huge amount. In FIG. 2, in order to increase the volume of the piston, the generator of the rotational movement (48) is switched on to drive the shaft and transfer movement to the upper and lower gears attached thereto (49). The upper and lower gears attached to the shaft will transfer the rotational movement to the gears of the upper and lower lids of the piston (50). In order to increase the weight of the piston, water is retained therein, as indicated in FIG. 3, by closing the cavities specialized for passing water in order for water to be retained therein, while the piston it totally submersed into water to get rid of air and increase the piston weight (57). FIG. 4 shows the opened upper lid of the piston which has to be closed to capture water in-between (43). FIG. 5 shows the opened lower lid of the piston, which has to be closed to capture water in-between (44). To further increase the piston weight, the inner cavities of the piston is filled with water through the following process. FIG. 1 shows the water tank used to pump water into the inner cavities of the piston (22). Then, the water pump (21) is operated to pump water through hose (30). FIG. 2 shows the water pipe (35) through which water flows to fill the inner cavities of the piston (46). During pumping water, the air channel is opened to allow the buoy (53) to be lowered and release air from the upper part of the cavities (46) by passing through the pipe (36), and then the air is discharged outside through hose (31). Water will push air outside the piston to be replaced by water. FIG. 1 shows a pump used to withdraw air to accelerate the entry of water into the same inner cavities of the piston (23). In FIG. 2, to ensure that air has been completely discharged from the inner cavities of the piston, a buoy carried by the water level is used until the inner cavities if totally filled with water, and then the buoy closes the air channel (53). FIG. 1 shows the water pump which is forced to stop as the inner cavities of the piston become totally filled with water (21), which sends an indication to the automatic control device that the process of increasing the piston weight, enlarging its volume and charging it with the required potential energy has been accomplished. FIG. 7 shows the piston being released from the lever (16) to pump the water to the turbine to produce energy with efficiency and capability as great as possible.

An illustrative method example of generating and producing energy, not limiting to numbers and ratios: a battery is externally charged, for the first time, by any type of energy; and after being fully charged to 100%, a second battery is charged from the first one, which loses about 30% of its original charge till the second battery is fully charged to 100%, to finally have 70% excess energy in the first battery and the second battery is 100% charged. This can be achieved by the present charging and production method, taking into consideration that the above-mentioned numbers are only for illustration, not limitation. After charging, two or more devices of the present invention start working alternatively to produce and store energy, through providing consumers with energy while using excess energy to charge the empty device. Such ratios are not fixed as they depend on the size of the well, the piston weight and the well height; the higher the well is, the greater the gravity force is, which leads to more acceleration of the piston to directly push water, and this in turn increases the velocity of the turbine to produce more energy with higher efficiency. The other factor that helps increasing the capability of the piston to produce energy is the direct increase of the piston weight while being continuously lowered to the downhole, since the water coming back of the turbine is combined in increasing amounts above the surface of the piston, which gives it more weight to push water existing under the piston with great strength toward the turbine to force it to generate increasing energy. To point out the potential difference between the processes of charging and energy production, the second battery, in the illustrative example, has been charged from the first battery, with the possibility of externally charging the two batteries directly by any other type of energy.

An illustrative, not limiting, example of using the well as a battery for storing energy: a battery produces about 70% more than its need to be charged; i.e., about 30% energy may be sufficient for the battery to be fully charged to 100%, and this difference is caused by the difference between the method of charging and production of energy. The present device may be charged by several types of energy, as indicated in the illustrative, not limiting, examples hereinafter.

The first example: the present device may be charged from an external general electric grid. This mode of charging may be used at peak hours to reduce charging costs and benefit from the consumption of battery energy at peak hours, to benefit from the cost difference.

The second example: the present device is charged from an additional battery that is used to store the excess unconsumed energy produced by the same device.

The third example: the present device may be charged from the excess energy produced by solar power during daytime, with the battery stored energy consumed at night.

The fourth example: the present device may be charged from the excess energy produced by wind power during, with the battery stored energy consumed on demand.

The fifth example: the present device may be charged from the excess energy produced by any type of clean renewable source, while the battery stored energy is consumed on demand.

The sixth example: the present device may be charged from an external general electric grid. This mode of charging may be used at any time, even at peak hours to make use of the great difference between the amount of electricity used in charging and the multiplied amount of energy provided by the battery.

The possibility of manufacturing the present device in different sizes according to the target consumer, as shown in the illustrative, non-limiting example:

The present device may be manufactured in different sizes to suit all social brackets benefiting from electricity. The size of the device depends on the amount of electricity required per hour, the period during which the device produces energy and the watt intensity required. For more illustration, the present device may be used, for example at home, factory or as an electric power station that produces thousands of megawatts.

An illustrative, non-limiting, example indicating the size and weights of the piston:

Assuming that the piston body weight in water is one ton, the piston then needs, to be lifted in water by floating force up to the top of the well, to be pumped by 1 m³ to 1.3 m³ of air in order for the piston weight to be less than zero approximately to float at water. This mentioned amount may differ depending on the different size and weight of the piston and the different density of water used inside the well.

An illustrative, non-limiting method example of increasing the piston weight to produce energy with efficiency as high as possible. The example indicates a method of increasing the piston weight to produce more energy by increasing the gravity acceleration of the piston, assuming that the piston body weight in water is one ton:

First: the piston needs to be pumped by an amount of water about 1.3 m³, equal to 1.3 ton weight, into the respective inner cavities of the piston.

Second, further amount of water, about 1.5 m³, equal to 1.5 ton weight, is captured inside the piston in the area specialized for passing water, enclosed by the upper and lower lids of the piston, in order for the piston weight to increase to 3.8 ton in sum, which gives the piston more strength to pump water to the turbine to produce more energy.

An illustrative, non-limiting method example of reducing the piston weight in order to reduce costs and potential needed to recharge the device.

To recharge the device, the piston, the total weight thereof is 3.8 as mentioned in the previous example, has to be lifted after producing the entire energy and reached to the downhole. Now, the piston should be able to float up to the top of the well by decreasing its weight:

First: the upper and lower lids of the piston, capturing huge amount of water (1.5 m³) equal to about 1.5 tons weight, are to be opened, and the piston weight is reduced to 2.3 tons.

Second, water has to be withdrawn from the inner cavities (containing about 1.3 m³ equal to 1.3 tons) of the piston so as for the weight of the piston stainless steel body to be 1 ton.

Third: After discharging water from the piston, air is to be pumped at the same amount and within the same inner cavities of the piston (the space thereof is 1.3 m³). The air causes the piston weight to be less than zero so as to float up to the top of the well, and hence the piston is lifted by the floating force. In addition, the electric lever may be used, in some cases, to lift the piston, when needed.

An illustrative, non-limiting example for the uses of the automatic control device that controls all the devices involved in the present invention, with the same methods and functions of such devices as previously indicated hereinbefore, as well as other devices will be described in detail later:

The mentioned control device is responsible for automatically managing all the processes of giving orders to the other devices used inside the well in order to facilitate managing the workflow of generating and storing hydroelectricity in at least one well. In addition, the mentioned device is able to control two wells or more working alternatively to generate and store energy. By adding more sensors, the automatic control device can determine the piston velocity, the remaining amount of water in order to deduct the predictable amount of energy to be produced, the amount of energy to be consumed and the excess part to be stored then transferred to another empty well, in case there are more than one well working alternatively, or to be stored in an external battery. Further, the control device controls the lever to stop the piston when there is no need to produce energy at the current time or if there is a huge excess energy produced.

Further, the automatic control device can preferably differentiate between the electric currents and which current would be used to charge the battery according to the settings and preferences determined by the consumer to get the least costs, since each country has its own prices for energy. Examples of settings and preferences of the present devices include, without limitation:

First: it is preferable to use an electric current from the second well that works alternatively with the other well, according to the present invention, to produce energy and store the excess energy to charge the empty well.

Second: it is preferable to use an electric current from an additional battery to preserve the excess energy produced by the same device.

Third: it is preferable to use an electric current from the excess energy produced by renewable sources, such as solar energy, wind energy and other types of renewable energy.

Fourth: it is preferable to use an electric current from an external general electric grid to reach low costs at off-peak hours, besides being used to cover shortage in some cases.

Fifth: two or more sources may be combined to provide energy needed for charging the well, together with providing consumers with sufficient energy, till the well is fully charged with minimum costs, since each country produces different types of energy at different prices.

An illustrative, non-limiting example for the uses of the lever:

First: the lever is used to lift the piston to the top of the well, when the device needs to be charged with energy.

Second: the lever may stop the piston till the piston weight and volume are increased, then the piston starts falling down to produce energy with high efficiency, without any points of weakness at the beginning of falling down.

Third: the piston is stopped by the lever when there is no need to produce energy, in order to preserve the potential energy currently existing inside the piston.

Non-limiting illustrative examples of devices, elements, internal and external parts of the well fed by the electric current are as follows:

### Electric Lever-Water Pump-Air Pump-Rotational Movement Tool-Automatic Control Device-Sensors

### Non-Limiting Illustrative Examples of Materials from which the Hydraulic Piston May be Made

The piston may be made from any stainless material or metal, such as stainless steel iron, stainless aluminum, stainless iron and aluminum, stainless concrete and iron, or a shaped rock.

### Non-Limiting Illustrative Example of Using the Piston Lids

The piston lids are movable to open and close the piston cavities, since the lids are opened to let water flow through the piston when it is lifted and to recharge the piston with the potential energy. Then, the piston lids are closed when energy is produced to capture water therein in order to increase the piston weight, and to increase the space facing the water to displace as much as possible of water.

### Non-Limiting Illustrative Example of Using Sensors

A compressible sensor is used at the wall of the well to detect the location of the piston, the arrival of the piston to the area of orientation change, wherein three, at least two, sensors are used at the top of the first well to give a sign of the piston arrival at the counter-direction area; the second sensor is used to ensure that the piston is totally submersed in water to start the process of increasing the piston volume and weight; and the third sensor is used at the downhole to give a counter-direction sign. More sensors may be added to determine the piston location, the produced amount of energy, the stored amount of energy and the piston velocity. together to operate two wells or more of the same invention, taking turns to produce and store energy from one device to the other.

1- A device for generating and storing hydroelectricity by pumping and storing liquid, wherein a heavy body (piston) (20) is to be lifted above the liquid surface using an electric turbine run in an opposite direction; said turbine withdraws the liquid from the top of the main well (58) and then pumps that liquid into a second path (9) downward to be introduced into the main well (58) from the bottom of the piston, pushing the piston to the highest level required inside the main well in order for the piston to gain a potential energy; to make use of such potential energy, the piston falls down on the liquid existing beneath it inside the main well (58) to transform the potential energy into a kinetic energy by gravity; the piston, while being lowered, will pump the liquid beneath it, pushing that liquid downward to enter into the second path (9) from the bottom flowing up, wherein that liquid passes by the turbine (4), which converts the liquid movement into an electric power; then the liquid is released from the turbine via the upper connecting channel (10), going back, from the top above the piston surface, to the main well, wherein said device consists of:
Main well (58), which is a first vertical cylindrical channel comprising a liquid and a piston;
Second path (9), which is a second vertical cylindrical channel attached to the bottom of the main well and parallel thereto, wherein the second path extends approximately along the main well, with a diameter significantly less than the main well channel, and contains liquid, and wherein that second path is attached from the top to the turbine through which the liquid passes to generate electricity;
An upper cylindrical connecting channel (10) which directs the liquid coming from the turbine back to the main well;
the present device has a piston (20) with an outer cylindrical shape and the same diameter length of the main well channel, and the inner part thereof is divided into two sections of cavities distributed in a manner that balances the piston weight and movement up and down within the main well channel;
The first section of the piston cavities has main paths (57) for passing the liquid, with upper (41) and lower (42) lids that may be opened to discharge the liquid captured in-between and to let the liquid in to facilitate lifting the piston from the bottom to the top of the main well, and vice versa, when energy is to be generated, before the fall of the piston downward to pump the liquid to the turbine, said paths (57) are closed with the liquid therein to benefit from the liquid weight captured inside the piston when it falls from the top of the main well down by the gravity to pump the liquid to the turbine;
The second section of the piston has tanks (46) with cavities internally connected to each other via a tube (37) to distribute weights by equally passing the liquid and the gas among all tanks, wherein such tanks (46) are closed from all outer sides and attached to a pump (21) to discharge the liquid from those tanks to an external tank (22) placed above the level of the main well (58) by pumping the liquid from those tanks (46) via the tube (46) attached to the tube (30) in order to pass the liquid to the external tank, then gas will replace the discharged liquid by introducing the gas via the tube (31) to pass through the tube (36) attached thereto n order for the gas to come into the tanks (46) inside the piston, which in turn reduces the weight and density of the piston and pushes it upward by the floating force; on contrary, when energy is to be generated, before the fall down of the piston, the liquid is directed back to the piston to regain its previous volume and weight in order to be able to pump the liquid to the turbine by recovering the liquid from the external tank (22) via the tube (30) attached to the liquid tube (35) and directing that liquid to the inner tanks of the piston (46), in such a manner that dismisses gas and replaces it with the liquid to increase the piston weight so as to be able to pump the liquid beneath it inside the main well to the turbine;
The present device is characterized with a piston that can be lifted by floating at the liquid after having its density reduced; wherein this can be achieved by getting rid of the liquid captured inside the piston through emptying the cavity of the piston tanks (46) from the liquid using a pump, then directing that liquid to an external tank (22) and replacing it with gas; in addition, upper (41) and lower (42) lids of the piston may be opened to get rid of the liquid captured therein and to let the liquid (57) pass through to facilitate lifting the piston from the bottom to the top of the main well by floating at the liquid, without the need to lift or dismiss the liquid existing above the piston surface, as there are paths to let the liquid pass through the piston;
The device further has an electric lever (16) attached to the piston from the top of the main well channel that can lift the piston without the need to lift or dismiss the liquid existing above the piston surface, as there are paths, having upper (41) and lower (42) lids opened, to let the liquid pass through the piston; and the lever is configured to manage the process of energy production, since, after the piston is lifted, the lever causes the piston to stop to regain its volume and weight, then the lever releases the piston to fall down on the liquid, thereby pumping the liquid to the turbine to generate electricity; if there is no need to generate energy, the lever stops the piston to preserve the potential energy therein;
The device is further characterized with a piston, the volume and weight thereof may increase to generate energy by the gravity; before the piston fall down, it regains its previous volume and weight to be able to pump the liquid to the turbine, wherein the piston weight may be increased by redirecting the liquid to the tanks (46) existing inside the piston through recovering the liquid from the external tank (22) via the tube (30) to the liquid tubes (35) then into the cavity of the tanks (46) inside the piston, thereby the piston become totally empty from gas that has been replaced by liquid, which in turn increases the piston weight equally to the liquid weight added thereto; in addition, the piston may gain more volume and weight by closing paths (57) of the liquid using upper (41) and lower (42) lids of the piston in order to retain the liquid therein so as to add more weight to the piston; then, the piston, with its increased weight, falls from the top of the main well (58) down on the liquid beneath it to pump that liquid by earth gravity; after that, the liquid starts its circle from the top to the bottom of the main well, then is introduced to the second path (9) to go upward to pass through the turbine to generate electricity, then the liquid is discharged from the turbine via the upper connecting channel to go back to the main well, whereby it increases the piston weight and its ability to pump the liquid existing beneath the piston.

2- A device for generating and producing hydroelectricity by pumping and storing liquid according to claim 1, wherein the top of the well cover is used to get the piston in and out.

3- A device for generating and producing hydroelectricity by pumping and storing liquid according to claim 1, wherein the well cover is provided with holes to control the pressure inside the well.

4- A device for generating and producing hydroelectricity by pumping and storing liquid according to claim 1, wherein a generator of electric power (turbine) is used to generate energy by pumping the liquid therein.

5- A device for generating and producing hydroelectricity by pumping and storing liquid according to claim 1, wherein the turbine controls the amount of liquid introduced to the generator of the electric power (the turbine) to increase or decrease the amount of energy produced.

6- A device for generating and producing hydroelectricity by pumping and storing liquid according to claim 1, further comprises a tube for feeding the well with liquid whenever the liquid is decreased by evaporation of any other way.

7- A device for generating and producing hydroelectricity by pumping and storing liquid according to claim 1, further comprises a buoy balancing the water level in the well.

8- A device for generating and producing hydroelectricity by pumping and storing liquid according to claim 1, wherein the water level in the well is normal.

9- A device for generating and producing hydroelectricity by pumping and storing liquid according to claim 1, wherein the second path is a second vertical cylindrical channel attached to the bottom of the main well and parallel thereto, wherein said second path extends along the main well channel with a diameter significantly less than the main well channel and contains the liquid, and wherein the second path is attached from the top to the turbine through which the liquid passes to generate electricity.

10- A device for generating and producing hydroelectricity by pumping and storing liquid according to claim 1, further comprises a liquid tube getting out of the power generator (turbine) back to the main well body.

11- A device for generating and producing hydroelectricity by pumping and storing liquid according to claim 1, further comprises a spiral spring protecting the piston and preventing the piston, as it moves with maximum speed, from falling down and crashing with the bottom of the main well.

12- A device for generating and producing hydroelectricity by pumping and storing liquid according to claim 1, further comprises a base holding both the main well body and the second path of the lateral tube to preserve their balance.

13- A device for generating and producing hydroelectricity by pumping and storing liquid according to claim 1, further comprises ropes, cables, wires, belts or chains, since all of them may be used to serve the same purpose, i.e. preserving the lifting balance of the piston and reducing the arbitrary movement of the piston during being lifted, which in turn would minimize the friction of the piston with the wall of the well.

14- A device for generating and producing hydroelectricity by pumping and storing liquid according to claim 1, further comprises a ring combining all ropes, cables, wires, belts or chains together, since all of them may be used to serve the same purpose, i.e. preserving the balance of the piston being lifted by the main rope attached to the lever.

15- A device for generating and producing hydroelectricity by pumping and storing liquid according to claim 1, further comprises a main lever rope, cable, wire, belt or chain, since all of them may be used for the same purpose of lifting the piston.

16- A device for generating and producing hydroelectricity by pumping and storing liquid according to claim 1, further comprises an electric level of the piston (lifting truck) used to lift the piston and control its movement via an automatic control device designed to manage the process of producing energy.

17- A device for generating and producing hydroelectricity by pumping and storing liquid according to claim 1, further comprises a base installed at the top of the well, designed to hold the electric level of the piston.

18- A device for generating and producing hydroelectricity by pumping and storing liquid according to claim 1, further comprises a lateral spring pushing a sensor.

19- A device for generating and producing hydroelectricity by pumping and storing liquid according to claim 1, further comprises a sensor attached to the wall of the well to detect the location of the piston, and hence determining the amount of energy produced, the amount of energy stored, the velocity of the piston, and the arrival of the piston to the area of changing its orientation.

20- A device for generating and producing hydroelectricity by pumping and storing liquid according to claim 1, further comprises a hydraulic liquid piston configured to pump the liquid toward the turbine to generate electric power, wherein said piston is made from any stainless material that may serve the purpose of the piston, i.e. pumping liquid within the hydraulic path from one end to the other;
Wherein the piston has many advantages as follows:
1—The piston uses the gravity force to produce energy.
2—The piston uses the floating force in liquids when the piston is lifted to produce energy.
3—The ability to enlarge the volume of the piston to pump great amount of liquid to produce energy.
4—The ability to decrease the volume of the piston to let the liquid pass therein while being lifted to be recharged.
5—The ability to increase the piston weight by filling the cavities of the piston with liquid to give the piston more weight for producing energy.
6—The ability to decrease the piston weight by discharging the liquid existing therein.
7—The ability to decrease the piston weight by adding gas inside the piston to reduce its weight and float at the liquid up to the top of the well.
21—A device for generating and producing hydroelectricity by pumping and storing liquid according to claim 1, further comprises a pump for pumping and withdrawing the liquid from the inner cavities of the piston.
22—A device for generating and producing hydroelectricity by pumping and storing liquid according to claim 1, further comprises an external liquid tank for providing the piston with the liquid and storing the liquid coming from the piston therein.
23—A device for generating and producing hydroelectricity by pumping and storing liquid according to claim 1, further comprises a pump for pumping and withdrawing gas from the inner cavities of the piston.
24—A device for generating and producing hydroelectricity by pumping and storing liquid according to claim 1, further comprises an electric current used as a source for providing energy needed for the well to be recharged from another well producing energy according to the present invention, wherein both wells work alternatively to produce and store energy, then use the excess energy to charge the empty well.
25—A device for generating and producing hydroelectricity by pumping and storing liquid according to claim 1, further comprises an electric current used as an energy source of an additional battery used for storing the excess energy produced according to the present invention, then said battery is used for recharging the present device and provide sufficient energy for the consumer till the device is fully charged with power.
26—A device for generating and producing hydroelectricity by pumping and storing liquid according to claim 1, further comprises an electric current used as a source for providing energy from the excess renewable energy produced, such as solar energy, wind energy or any other type of clean renewable energy.
27—A device for generating and producing hydroelectricity by pumping and storing liquid according to claim 1, further comprises an electric current used as a source for providing energy from a general external electric grid in order to overcome shortage in some cases.
28—A device for generating and producing hydroelectricity by pumping and storing liquid according to claim 1, further comprises an electric current produced according to the present invention to be consumed, with excess energy being stored.
29—A device for generating and producing hydroelectricity by pumping and storing liquid according to claim 1, further comprises an extendable and shrinkable helical tube combining gas and liquids hosepipes and electric wires attached to the piston, preserving its order, preventing it from getting inside the cavities of the piston and isolating it from the liquid.
30—A device for generating and producing hydroelectricity by pumping and storing liquid according to claim 1, further comprises a hose tube for passing the liquid in and out of the piston.
31—A device for generating and producing hydroelectricity by pumping and storing liquid according to claim 1, further comprises a hose tube for passing the gas in and out of the piston.
32—A device for generating and producing hydroelectricity by pumping and storing liquid according to claim 1, further comprises electric wires directed inside the piston so as to feed the devices inside the piston with electricity.
33—A device for generating and producing hydroelectricity by pumping and storing liquid according to claim 1, an insulator of the tube introduced inside the central area of the piston through which hosepipes and electric wires pass to prevent the entry of liquids and gases to the central area of the piston.
34—A device for generating and producing hydroelectricity by pumping and storing liquid according to claim 1, wherein the tube getting inside the central area of the piston comprises all liquid and gas pipes and electric wires directed into the piston.
35—A device for generating and producing hydroelectricity by pumping and storing liquid according to claim 1, further comprises a tube introduced into the piston for pumping and withdrawing the liquid from the inner cavities of the piston.
36—A device for generating and producing hydroelectricity by pumping and storing liquid according to claim 1, further comprises a tube introduced into the piston for pumping and withdrawing the gas from the inner cavities of the piston.
37—A device for generating and producing hydroelectricity by pumping and storing liquid according to claim 1, further comprises a tube connecting the inner cavities of the piston in order to distribute the gas and the liquid among the cavities in balance.
38—A device for generating and producing hydroelectricity by pumping and storing liquid according to claim 1, further comprises a gear attached to the upper and lower lids of the piston, which moves with the respective lid.
39—A device for generating and producing hydroelectricity by pumping and storing liquid according to claim 1, further comprises grids fixed at the upper lid of the piston preventing the passage of any solid body to the central area of the piston at the space opened for passing the liquid.
40—A device for generating and producing hydroelectricity by pumping and storing liquid according to claim 1, further comprises one of the slices used for closing the holes of the piston, which constitutes a part of the moving upper lid of the piston, wherein the slice has a protrusion at the middle for smooth flowing of the liquid toward the holes of the piston, and wherein the number of such slices may increase or decrease, depending on the size and diameter of the piston; the greater the size of the piston is, the more holes may be added to ensure smooth flow of water and balanced movement of the piston, in addition to minimizing the friction of the piston with the wall of the well.
41—A device for generating and producing hydroelectricity by pumping and storing liquid according to claim 1, wherein the upper piston lid is closed electrically to retain the liquid inside the cavity of the paths specialized for allowing the liquid to pass through it to increase the piston weight and volume from the top, which in turn provides more stiffness to the piston to withstand the pressure of the liquid returning from the turbine to the main well channel, and wherein the upper piston lid is opened electrically to release the liquid captured inside the cavity of the paths specialized for allowing the liquid to pass through the piston, thereby reducing the piston weight and volume so as to be lifted with no need to lift or dispense the liquid existing above the piston surface in the main well channel.
42—A device for generating and producing hydroelectricity by pumping and storing liquid according to claim 1, wherein the lower piston lid is closed automatically to prevent the passage of the liquid through the piston and to retain the liquid inside the cavity of the paths specialized for the passage of the liquid, which in turn increases the piston weight and volume; in addition, closing the lid gives the piston more strength to pump the liquid captured beneath it inside the main well channel toward the turbine to generate electricity, and wherein the lower piston lid is opened electrically to release the liquid captured inside the cavity of the paths specialized for allowing the liquid pass through the piston, thereby decreasing the piston weight and volume so as to be lifted without the need to lift or dismiss the liquid existing above the piston surface in the main well channel.
43—A device for generating and producing hydroelectricity by pumping and storing liquid according to claim 1, wherein the piston is lifted by floating at the liquid after discharging the liquid from the cavity of the piston tanks and introducing gas instead, in addition to opening the upper and lower paths of the piston to let the liquid flow through the piston so as to be lifted by the floating force.
44—A device for generating and producing hydroelectricity by pumping and storing liquid according to claim 1, wherein said device generates energy by earth gravity through a hydraulic piston moving up and down within the main well channel, wherein said device is run in a hydraulic manner to pump the liquid from the large sectional end comprising the piston to the other small sectional end comprising the turbine so as for the movement to be transferred from the piston to the turbine via the liquid, then the turbine converts the liquid movement into hydroelectricity.
45—A device for generating and producing hydroelectricity by pumping and storing liquid according to claim 1, wherein the inner fixed parts of the piston are divided into two sections of cavities distributed in a manner that makes balance in the piston weight and movement up and down inside the main well channel, wherein the second section of the piston comprises tanks, which are closed from the top and the bottom to prevent the liquid flow through the piston; wherein it is preferable for such cavities to have predetermined outer shape and predetermined tank size to deduct the number of sections it may be divided into to make balance in the piston weight and movement up and down, besides making use of the entire inner space of the piston by dividing it into two sections of fixed parts and paths for allowing the liquid to flow through the piston, with the purpose of increasing the smoothness of the liquid flow within the first part of the piston, and wherein the lids may take the same shape of the fixed parts when the upper and lower lids are opened, so the fixed parts are matched and the liquid smoothly flows through the piston while being lifted upward inside the main well channel.
46—A device for generating and producing hydroelectricity by pumping and storing liquid according to claim 1, further comprises a tank with an inner cavity for one of the fixed parts of the piston, which is used to retain gas therein during lifting the piston and to retain liquid therein during lowering the piston to produce energy.
47—A device for generating and producing hydroelectricity by pumping and storing liquid according to claim 1, further comprises an inflation port used for preserving the volume and pressure of the gas from getting extended inside the piston between different levels, in addition to preventing the over-inflation of the volume and pressure of the gas by releasing the gas from the inner cavities of the piston.
48—A device for generating and producing hydroelectricity by pumping and storing liquid according to claim 1, further comprises a generator of rotational movement for both the upper and lower lids of the piston.
49—A device for generating and producing hydroelectricity by pumping and storing liquid according to claim 1, further comprises a shaft which transfers movement of the generator to the gears.
50—A device for generating and producing hydroelectricity by pumping and storing liquid according to claim 1, further comprises a gear of rotational movement attached to the shaft to transfer movement to the gears of upper and lower lids.
51—A device for generating and producing hydroelectricity by pumping and storing liquid according to claim 1, further comprises a piston ring made of stainless iron or any other stainless material that serves the purpose of preventing the liquid from passing by the piston.
52—A device for generating and producing hydroelectricity by pumping and storing liquid according to claim 1, further comprises a piston ring made of rubber used in hydraulic systems, placed between the rings made of stainless iron and serves the purpose of preventing the liquid from passing by the piston.
53—A device for generating and producing hydroelectricity by pumping and storing liquid according to claim 1, further comprises a floating buoy used for closing the gas channel when liquid level reaches its maximum value and the inner cavity of the piston is totally filled with liquid.
54—A device for generating and producing hydroelectricity by pumping and storing liquid according to claim 1, further comprises a lower support of the piston protecting the bottom of the piston from clashing with the spring placed at the downhole to stop the rushing piston in order not to clash with the downhole.
55—A device for generating and producing hydroelectricity by pumping and storing liquid according to claim 1, wherein the central area of the piston is a backbone connecting all parts of the piston together to give the piston more power while being isolated from liquid and gas, except through the respective tubes, as they contain small cavities having a generator of rotational movement therein attached to the shaft connected to the gears, which contain a cavity for passing liquid and gas pipes, as well as the electric wires.
56—A device for generating and producing hydroelectricity by pumping and storing liquid according to claim 1, further comprises an automatic control device used for managing the workflow of energy production and storage, as well as controlling all involved devices.
57—A device for generating and producing hydroelectricity by pumping and storing liquid according to claim 1, wherein the piston cavities are used for allowing the liquid into the piston while being lifted, and may further be used for retaining the liquid therein while the piston is lowered to produce energy, wherein the number of such cavities may increase or decrease depending on the size of the piston diameter; the greater the size of the piston is, the more holes that may be added, wherein it is preferable for the number of the fixed parts of the piston to be equal to the numbers of spaces specialized for passing of liquid through the piston in order to ensure the smooth flow of the liquid, the balanced movement of the piston and reduced friction with the wall of the well.
58—A device for generating and producing hydroelectricity by pumping and storing liquid according to claim 1, further comprises an empty main well body configured to be filled with liquid without any leakage. Said well body is used for generating energy by the hydraulic method through pumping the liquid from one part to the other, wherein it is attached to a second path from the bottom to the top in order to pump the liquid in the direction of the second lateral path toward the turbine to produce energy. Additionally, the main well also has a hydraulic piston therein for pumping the liquid to produce energy. The well body may be placed on earth, or partially buried or totally buried under ground.
59—A device for generating and producing hydroelectricity by pumping and storing liquid according to claim 1, wherein two or more of the above-mentioned elements (24-25-26-27) may be combined together to provide an energy source for charging the device and providing consumers with energy till the device is charged with energy with minimum cost, since each country has its own different circumstances.
60—A device for generating and producing hydroelectricity by pumping and storing liquid according to claim 1, further comprises a source for providing energy for charging the present device in an alternative manner, using all elements (1-2-3-4-5-6-7-8-9-10-11-12-13-14-15-16-17-18-19-20-21-22-23-34-25-26-27-28-29-30-31-32-33-34-35-36-37-38-39-40-41-42-43-44-45-46-47-48-49-50-51-52-53-54-55-56-57-58-59) together to operate two wells or more of the same invention, taking turns to produce and store energy from one device to another.
